(19) United States
(12) Patent Application Publication
(10) Pub. No.: US 2026/0328987 A1
(43) Pub. Date: Oct. 22, 2026

(54) SYSTEM AND METHOD FOR ALIGNING DIFFRACTIVE FEATURES

(71) Applicant: Vuzix Corporation, West Henrietta, NY (US)

(72) Inventors: Robert J. Schultz, Victor, NY (US); Marek W. Kowarz, West Henrietta, NY (US); Brian R. Mentz, Jacksonville, VT (US); Mitchell G. Knoebel, Webster, NY (US)

(21) Appl. No.: 19/122,916

(22) PCT Filed: Dec. 6, 2023
(86) PCT No.: PCT/US2023/082654

§ 371 Date: Apr. 21, 2025

Related U.S. Application Data
(60) Provisional application No. 63/478,595, filed on Jan. 5, 2023.

(51) Int. Cl. F21V 8/00; G02B 27/01

(52) U.S. Cl. CPC G02B 6/0065; G02B 6/0036; G02B 27/0172

(57) ABSTRACT

A method and system forming a double-sided image light guide with aligned diffractive features. The image light guide includes a first side including a first diffractive optic and a second side including a second diffractive optic. To form the image light guide, at least one fiducial is arranged in a first mold, a second mold, and/or a substrate. The substrate is arranged on one of the first mold and the second mold. The at least one fiducial is used to align the first mold, the second mold, and/or the substrate.

### CROSS-REFERENCE TO RELATED APPLICATIONS

This application claims the benefit under Articles 4 and 8 of the Stockholm Act of the Paris Convention for the protection of Industrial Property of U.S. Patent Application No. 63/478,595, filed on Jan. 5, 2023, which application is incorporated by reference in its entirety.

### TECHNICAL FIELD

The present disclosure generally relates to electronic displays, and more particularly, to displays utilizing image light guides with diffractive optics to convey image-bearing light to a viewer.

### BACKGROUND

Head-Mounted Displays (HMDs) are being developed for a range of diverse uses, including military, commercial, industrial, firefighting, and entertainment applications. For many of these applications, there is particular value in forming a virtual color image that can be visually superimposed over the real-world image that lies in the field of view of the HMD user. Optically transparent flat parallel plate waveguides, also called planar waveguides, convey image-bearing light generated by a color projector system to the HMD user. The planar waveguides convey the image-bearing light in a narrow space to direct the virtual image to the HMD user's pupil and enable the superposition of the virtual image over the real-world image that lies in the field of view of the HMD user.

In such conventional imaging light guides, collimated, relatively angularly encoded light beams from a polychromatic or monochromatic image projector source are coupled into an optically transparent planar waveguide by an input coupling optic, such as an in-coupling diffractive optic, which can be mounted or formed on a surface of the parallel plate planar waveguide or disposed within the waveguide. Such diffractive optics can be formed as diffraction gratings, holographic optical elements, or in other known ways. For example, the diffraction grating can be formed as a surface relief grating. After propagating along the planar waveguide, the diffracted color image-bearing light can be directed back out of the planar waveguide by a similar output grating, which may be arranged to provide pupil expansion in one or more dimensions. In addition, one or more diffractive turning gratings may be positioned along the waveguide optically between the input and output gratings to provide pupil expansion in one or more dimensions. The image-bearing light output from the parallel plate planar waveguide provides an expanded eyebox for the viewer.

A HMD system may consist of at least one image conveying waveguide for conveying virtual image-encoded light to the left eye of the viewer and at least one image conveying waveguide for conveying virtual image-encoded light to the right eye of the viewer, thus enabling stereo and/or three-dimensional images to be seen by the viewer.

Current systems for virtual image reconstruction require multiple waveguides, for example, a waveguide stack, where one waveguide is utilized for each wavelength range of light. For example, a first waveguide of the waveguide stack may be used to convey light in the red wavelength range, and a second waveguide of the waveguide stack may be used to convey light in the blue wavelength range. The use of multiple waveguides increases costs, package size, and additional weight, as well as the potential for manufacturing defects and ingress of pollutants (e.g., dust particles, moisture, etc.). Additionally, while it is possible to arrange diffractive optic gratings on both sides of a waveguide, current methods for doing so present a risk of alignment errors, which tend to effect cosmetics, and can affect input/output efficiency of the diffractive optic gratings (e.g., a user may see a red glow from an edge, one of the input gratings could be shifted relative to the projector location, etc.).

### SUMMARY

The present disclosure is directed to one or more exemplary embodiments of a method and system forming a double-sided image light guide with aligned diffractive features. The image light guide includes a first side comprising a first diffractive optic and a second side comprising a second diffractive optic. To form the image light guide, at least one fiducial is arranged in a first mold, a second mold, and/or a substrate. The substrate is arranged on one of the first mold, the second mold, or a platform. The at least one fiducial is used to align the first mold, the second mold, and/or the substrate.

The present disclosure is directed to one or more exemplary embodiments of a method of forming an image light guide.

In an exemplary embodiment, the method may comprise forming a first diffractive optic and a first fiducial on a first surface of a substrate using a first mold, aligning the substrate with a second mold, and forming a second diffractive optic in a second surface of the substrate, opposite the first surface.

In an exemplary embodiment, the first diffractive optic is formed by first diffractive features arranged on the first mold and the first fiducial is formed by second diffractive features arranged on the first mold. In an exemplary embodiment, the first diffractive features and the second diffractive features comprise a negative pattern of diffractive features and, once formed, the first diffractive optic and the first fiducial comprises a positive pattern of diffractive features. In an exemplary embodiment, the first diffractive optic and the first fiducial are formed on or in the first surface simultaneously. In an exemplary embodiment, the first fiducial is arranged outside of a perimeter of the image light guide. In an exemplary embodiment, the method further comprises removing a portion of the substrate, e.g., the portion comprising the first fiducial. In an exemplary embodiment, the step of aligning the substrate with the second mold comprises aligning the first fiducial with a second fiducial arranged on or in the second mold. In an exemplary embodiment, at least one of the first diffractive optic portion and the first fiducial portion comprises diffractive features. In an exemplary embodiment, both of the first diffractive optic portion and the first fiducial comprise diffractive features. In an exemplary embodiment, the step of aligning the substrate with a second mold comprises engaging the substrate with at least one alignment protrusion.

The present disclosure is directed to one or more exemplary embodiments of a method of aligning diffractive features on a substrate.

In an exemplary embodiment, the method may comprise providing an image light guide forming system, the system including a first mold and a second mold, the first mold having first diffractive features and second diffractive features and the second mold having third diffractive features, depositing a first material on a first surface of a substrate, forming a first diffractive optic and a first fiducial within the first material by compressing the first mold and the first surface of the substrate, and aligning the first fiducial of the substrate with the second fiducial of the second mold.

In an exemplary embodiment, the method further comprises depositing a second material on a second surface of the substrate, opposite the first surface of the substrate, and forming a second diffractive optic within the second material by compressing the second mold and the second surface of the substrate. In an exemplary embodiment, the second diffractive optic is formed by the third diffractive features. In an exemplary embodiment, the first diffractive optic is formed by the first diffractive features and the first fiducial is formed by the second diffractive features. In an exemplary embodiment, the first diffractive optic and the first fiducial are formed in the first material simultaneously. In an exemplary embodiment, the method further comprises forming a third fiducial in the second material. In an exemplary embodiment, the first fiducial is arranged outside of a perimeter of the image light guide. In an exemplary embodiment, the method further comprises removing a portion of the substrate, e.g., a portion along the perimeter, to remove the first fiducial and form the image light guide. In an exemplary embodiment, the first diffractive optic and the first fiducial comprise diffractive features. In an exemplary embodiment, the method further comprises curing the first material using ultraviolet light. In an exemplary embodiment, the step of curing the first material using ultraviolet light comprises arranging the substrate on a surface, directing the ultraviolet light through one of the first mold and the surface, and then through the substrate, and reflecting the ultraviolet light off of the other of the first mold and the surface.

The present disclosure is directed to one or more exemplary embodiments of forming an image light guide.

In an exemplary embodiment, the method comprises aligning a substrate with one of a first mold and a second mold, the substrate including a first surface and a second surface, and at least the first mold comprises first negative diffractive optic features and first negative fiducial features, and forming a first positive diffractive optic and a first positive fiducial in at least one of the first surface and the second surface, wherein the first positive fiducial is arranged outside of a perimeter of the image light guide, and the first positive diffractive optic and the first positive fiducial comprise diffractive features.

The present disclosure is directed to one or more exemplary embodiments of a method of forming an image light guide.

In an exemplary embodiment, the method of forming an image light guide may comprise arranging at least one fiducial in an image light guide forming system, arranging a substrate on one of a first mold and a second mold of the image light guide forming system, the substrate including a first surface and a second surface, aligning the image light guide forming system using the at least one fiducial; and forming a diffractive optic in at least one of the first surface and the second surface to form the image light guide.

In an exemplary embodiment, the step of arranging the at least one fiducial in the image light guide forming system comprises forming a first fiducial in at least one of the first mold and the second mold. In an exemplary embodiment, the step of arranging the at least one fiducial in the image light guide forming system comprises forming a first fiducial in the first mold, and forming a second fiducial in the second mold. In an exemplary embodiment, the step of aligning the image light guide forming system using the at least one fiducial comprises aligning the first fiducial with the second fiducial. In an exemplary embodiment, the step of arranging the at least one fiducial in the image light guide forming system comprises forming a first fiducial in the first mold, and forming a second fiducial in the substrate. In an exemplary embodiment, the step of aligning the image light guide forming system using the at least one fiducial comprises aligning the first fiducial with the second fiducial.

In an exemplary embodiment, the step of arranging the at least one fiducial in the image light guide forming system comprises forming a first fiducial comprising a diffractive optic in at least one of the first mold, the second mold, and the substrate. In an exemplary embodiment, the method further comprises, prior to the step of forming the diffractive optic in at least one of the first surface and the second surface, applying a layer to at least one of the first surface and the second surface. In an exemplary embodiment, the method further comprises curing the layer using ultraviolet light. In an exemplary embodiment, the diffractive optic is formed in the layer. In an exemplary embodiment, the step of arranging the at least one fiducial in the image light guide forming system comprises connecting at least one alignment protrusion to the first mold or the second mold. In an exemplary embodiment, the step of aligning the image light guide forming system using the at least one fiducial comprises engaging the substrate with the at least one alignment protrusion. In an exemplary embodiment, the step of aligning the image light guide forming system using the at least one fiducial comprises detecting a location of the at least one fiducial using a vision system. In an exemplary embodiment, the method further comprises removing a portion of the substrate. In an exemplary embodiment, the portion comprises the at least one fiducial.

The present disclosure is directed to one or more exemplary embodiments of a method of forming an image light guide.

In an exemplary embodiment, the method of forming an image light guide may comprise forming a first fiducial in a first mold, forming a second fiducial in a second mold, arranging a substrate on one of the first mold and the second mold, aligning the first fiducial and the second fiducial, and using at least one of the first mold and the second mold, forming a diffractive optic in at least one surface of the substrate to form the image light guide.

In an exemplary embodiment, the first fiducial and the second fiducial are aligned using a vision system. In an exemplary embodiment, the method further comprises aligning the substrate on the one of the first mold and the second mold using at least one alignment protrusion. In an exemplary embodiment, at least one of the first fiducial and the second fiducial comprises a diffractive optic.

The present disclosure is directed to one or more exemplary embodiments of an image light guide forming system.

In an exemplary embodiment, the image light guide forming system may comprise a first mold comprising a first diffractive optic marking and a first fiducial, a second mold including a second diffractive optic marking and a second fiducial, and a vision system operatively arranged to facilitate alignment of the first fiducial and the second fiducial, wherein the first diffractive optic marking and the second diffractive optic marking are operatively arranged to simultaneously engage a substrate to form a first diffractive optic on a first surface of the substrate and a second diffractive optic on a second surface of the substrate, opposite the first surface.

These and other aspects, objects, features, and advantages of the present disclosure will be more clearly understood and appreciated from the following detailed description of the embodiments and appended claims, and by reference to the accompanying drawing figures.

### BRIEF DESCRIPTION OF THE DRAWING FIGURES

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a top view of an image light guide with an exaggerated thickness for showing the propagation of light from an image source along the image light guide to an eyebox within which the virtual image can be viewed.

FIG. 2 is a perspective view of an image light guide including an in-coupling diffractive optic, a turning diffractive optic, and an out-coupling diffractive optic for managing the propagation of image-bearing light beams.

FIG. 3A is a top perspective view of a substrate including an image light guide and a fiducial.

FIG. 3B is a top plan view of the substrate shown in FIG. 3A.

FIG. 3C is a bottom plan view of the substrate shown in FIG. 3A.

FIG. 4 is a cross-sectional view of the substrate taken generally along line 4-4 in FIG. 3A.

FIG. 5 is a side elevational view of an image light guide forming system.

FIG. 6 is a side elevational view of the image light guide forming system shown in FIG. 5.

FIG. 7 is a side elevational view of an image light guide forming system.

FIG. 8 is a side elevational view of an image light guide forming system.

FIG. 9 is a side elevational view of an image light guide forming system.

FIG. 10 is a side elevational view of an image light guide forming system.

FIG. 11A is a top perspective view of an image light guide.

FIG. 11B is a top plan view of the image light guide shown in FIG. 11A.

FIG. 11C is a bottom plan view of the image light guide shown in FIG. 11A.

FIG. 12A is a top perspective view of an image light guide.

FIG. 12B is a top plan view of the image light guide shown in FIG. 12A.

FIG. 12C is a bottom plan view of the image light guide shown in FIG. 12A.

FIG. 13A is a top perspective view of an image light guide.

FIG. 13B is a top plan view of the image light guide shown in FIG. 13A.

FIG. 13C is a bottom plan view of the image light guide shown in FIG. 13A.

FIG. 14 is a plan view of a substrate including image light guides having fiducials.

FIG. 15 is a plan view of a substrate including image light guides and a fiducial.

FIG. 16 is a plan view of a mold including a fiducial.

FIG. 17 is a plan view of the mold shown in FIG. 16, with a substrate arranged thereon.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Where used herein, the terms “first,” “second,” and so on, do not necessarily denote any ordinal, sequential, or priority relation, but are simply used to more clearly distinguish one element or set of elements from another, unless specified otherwise.

Where used herein, the terms “viewer,” “operator,” “observer,” “wearer,” and “user” are considered equivalents and refer to the person or machine who wears and/or views images using a head mounted device.

Where used herein, the term “set” refers to a non-empty set, as the concept of a collection of elements or members of a set is widely understood in elementary mathematics. The term “subset,” unless otherwise explicitly stated, is used herein to refer to a non-empty proper subset, that is, to a subset of the larger set, having one or more members. For a set S, a subset may comprise the complete set S. A “proper subset” of set S, however, is strictly contained in set S and excludes at least one member of set S.

Where used herein, the terms “coupled,” “coupler,” or “coupling” in the context of optics refer to a connection by which light travels from one optical medium or device to another optical medium or device.

Where used herein, the term “beam expansion” is intended to mean replication of a beam via multiple encounters with an optical element to provide exit pupil expansion in one or more dimensions. Similarly, where used herein, the terms “expanded image-bearing light beams” and “expanded set of angularly related beams” refer to a light beam replicated via multiple encounters with an optical element to provide exit pupil expansion in one or more dimensions.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

Where used herein, the term “substantially” is intended to mean within the tolerance range of the equipment used to produce the value, or, in some examples, is intended to mean plus or minus 10%, or plus or minus 5%, or plus or minus 1%, unless otherwise expressly specified.

Where used herein, the term “exemplary” is intended to mean “an example of,” “serving as an example,” or “illustrative,” and does not denote any preference or requirement with respect to a disclosed aspect or embodiment.

An optical system, such as a HMD, can produce a virtual image display. In contrast to methods for forming a real image, a virtual image is not formed on a display surface. That is, if a display surface were positioned at the perceived location of a virtual image, no image would be formed on that surface. Virtual image display has a number of inherent advantages for augmented reality presentation. For example, the apparent size of a virtual image is not limited by the size or location of a display surface. Additionally, the source object for a virtual image may be small; for example, a magnifying glass provides a virtual image of an object. In comparison with systems that project a real image, a more realistic viewing experience can be provided by forming a virtual image that appears to be some distance away. Providing a virtual image also obviates the need to compensate for screen artifacts, as may be necessary when projecting a real image.

An image light guide may utilize image-bearing light from a light source such as a projector to display a virtual image. For example, collimated, relatively angularly encoded, light beams from a projector are coupled into a planar waveguide by an input coupling such as an in-coupling diffractive optic, which can be mounted or formed on a surface of the planar waveguide or integrated within the waveguide. Such diffractive optics can be formed as diffraction gratings, holographic optical elements (HOEs), or in other known ways. For example, the diffraction grating can be formed by surface relief. After propagating along the waveguide, the diffracted light can be directed back out of the waveguide by a similar output coupling such as an out-coupling diffractive optic, which can be arranged to provide pupil expansion along one dimension of the virtual image. In addition, a turning grating can be positioned on/in the waveguide to provide pupil expansion in an orthogonal dimension of the virtual image. The image-bearing light output from the waveguide provides an expanded eyebox for the viewer.

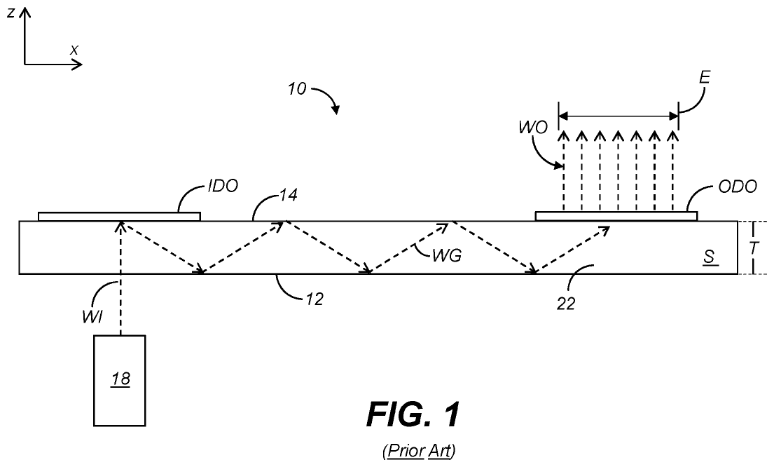

As illustrated in FIG. 1, image light guide 10 may comprise planar waveguide 22 having plane-parallel surfaces 12, 14. Waveguide 22 comprises transparent substrate S, which, for example, can be made of optical glass or plastic, having plane parallel first and second surfaces 12, 14. In this example, in-coupling diffractive optic IDO and out-coupling diffractive optic ODO are arranged on second surface 14, and in-coupling diffractive optic IDO is a reflective-type diffraction grating through which image-bearing light WI is coupled into planar waveguide 22. However, in-coupling diffractive optic IDO could alternately be a volume hologram or other holographic diffraction element, or other type of optical component that provides diffraction for the incoming, image-bearing light WI. In-coupling diffractive optic IDO can be located on first surface 12 or second surface 14 of planar waveguide 22 and can be of a transmissive or reflective type depending upon the direction from which image-bearing light WI approaches planar waveguide 22.

When used as a part of a virtual display system, in-coupling diffractive optic IDO couples image-bearing light WI from real image source 18 into substrate S of planar waveguide 22. Any real image or image dimension is first converted into an array of overlapping angularly related beams encoding the different positions within an image for presentation to in-coupling diffractive optic IDO. Image-bearing light WI is diffracted (generally through a first diffraction order) and thereby redirected by in-coupling diffractive optic IDO into planar waveguide 22 as image-bearing light WG for further propagation along planar waveguide 22 by Total Internal Reflection (“TIR”). Although diffracted into a generally more condensed range of angularly related beams in keeping with the boundaries set by TIR, image-bearing light WG preserves the image information in an encoded form. Out-coupling diffractive optic ODO receives the encoded image-bearing light WG and diffracts (also generally through a first diffraction order) image-bearing light WG out of planar waveguide 22 as image-bearing light WO toward the intended location of a viewer's eye. Generally, out-coupling diffractive optic ODO is designed symmetrically with respect to in-coupling diffractive optic IDO to restore the original angular relationships of image-bearing light WI among outputted angularly related beams of image-bearing light WO. However, to increase one dimension of overlap among the angularly related beams in a so-called eyebox E within which the virtual image can be seen, out-coupling diffractive optic ODO is arranged to encounter image-bearing light WG multiple times and to diffract only a portion of image-bearing light WG on each encounter. The multiple encounters along the length of out-coupling diffractive optic ODO have the effect of enlarging one dimension of each of the angularly related beams of image-bearing light WO thereby expanding one dimension of eyebox E within which the beams overlap. Expanded eyebox E decreases sensitivity to the position of a viewer's eye for viewing the virtual image.

Out-coupling diffractive optics with refractive index variations along a single dimension can expand one dimension of the eyebox by replicating the individual angularly related beams in their direction of propagation along the waveguide between encounters with the out-coupling diffractive optic. The refractive index variations may be in the form of surface relief gratings or holographic optical elements. In addition, out-coupling diffractive optics with refractive index variations along a second dimension can expand a second dimension of the eyebox and provide two-dimensional expansion of the eyebox. The refractive index variations along a first dimension of the out-coupling diffractive optic can be arranged to diffract a portion of each beam's energy out of the waveguide upon each encounter therewith through a desired first order of diffraction, while another portion of the beam's energy is preserved for further propagation in its original direction through a zero order of diffraction. The refractive index variations along a second dimension of the out-coupling diffractive optic can be arranged to diffract a portion of each beam's energy upon each encounter therewith through a desired first order of diffraction in a direction angled relative to the beam's original direction of propagation, while another portion of the beam's energy is preserved for further propagation in its original direction through a zero order of diffraction.

Out-coupling diffractive optic ODO is shown as a transmissive-type diffraction grating arranged on second surface 14 of planar waveguide 22. However, like in-coupling diffractive optic IDO, out-coupling diffractive optic ODO can be located on first surface 12 or second surface 14 of planar waveguide 22 and be of a transmissive or reflective type in a combination that depends upon the direction through which image-bearing light WG is intended to exit planar waveguide 22.

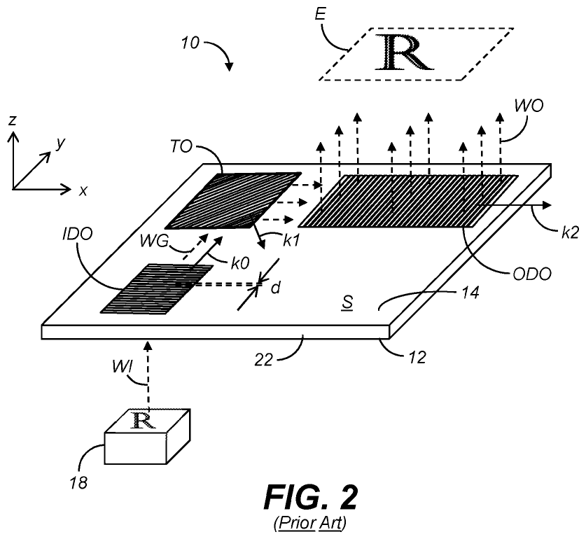

As illustrated in FIG. 2, image light guide 20 may be arranged for expanding eyebox E in two dimensions, i.e., along both x-and y-axes of the intended image. To achieve a second dimension of beam expansion, in-coupling diffractive optic IDO, having grating vector k0, is oriented to diffract a portion of image-bearing light WI toward intermediate optic TO, having grating vector k1, which is oriented to diffract a portion of image-bearing light WG in a reflective mode toward out-coupling diffractive optic ODO. Intermediate optic TO may be referred to herein as a turning grating or turning optic. In an embodiment, intermediate optic TO is a surface relief grating. In another embodiment, intermediate optic TO is a holographic optical element. Only a portion of image-bearing light WG is diffracted by each of multiple encounters with intermediate optic TO thereby laterally replicating each of the angularly related beams of image-bearing light WG approaching out-coupling diffractive optic ODO. Intermediate optic TO redirects image-bearing light WG toward out-coupling diffractive optic ODO for longitudinally replicating the angularly related beams of image-bearing light WG in a second dimension before exiting planar waveguide 22 as he image-bearing light WO. Grating vectors, such as the depicted grating vectors k0, k1, k2, extend in a direction that is normal to the diffractive features (e.g., grooves, lines, or rulings) of the diffractive optics and have a magnitude inverse to the period or pitch d (i.e., the on-center distance between grooves) of diffractive optics IDO, TO, ODO. In-coupling diffractive optic IDO, intermediate optic TO, and out-coupling diffractive optic ODO may each have a different period or pitch d.

With continued reference to FIG. 2, in-coupling diffractive optic IDO receives incoming image-bearing light WI containing a set of angularly related beams corresponding to individual pixels or equivalent locations within an image generated by image source 18. Image source 18, operable to generate a full range of angularly encoded beams for producing a virtual image, may be, but is not limited to, a real display together with focusing optics, a beam scanner for more directly setting the angles of the beams, or a combination such as a one-dimensional real display used with a scanner. In some examples, image source 18 comprises one or more light-emitting diodes (LEDs), organic LEDs (OLEDs), or micro LEDs (μLEDs). In other examples, image source 18 is a color field sequential projector system operable to pulse image-bearing light of multiple wavebands, for example light from within red, green, and blue wavelength ranges, onto a digital light modulator/micro-mirror array (a “DLP”) or a liquid crystal on silicon (“LCOS”) display. In further examples, image source 18 includes one or more pico-projectors, where each pico-projector is configured to produce a single primary color band (e.g., red, green, or blue). In another example, image source 18 includes a single pico-projector arranged to produce all three primary color bands (e.g., red, green, and blue). In one example, the three primary color bands are a green band having a wavelength in the range between 495 nm and 570 nm, a red band having a wavelength in the range between 620 nm and 750 nm, and a blue band having a wavelength in the range between 420 nm and 495 nm.

Image light guide 20 outputs an expanded set of angularly related beams in two dimensions of the image by providing multiple encounters of image-bearing light WG with both intermediate optic TO and out-coupling diffractive optic ODO in different orientations. In the original orientation of planar waveguide 22, intermediate grating TO provides beam expansion in the y-axis direction, and out-coupling diffractive optic ODO provides a similar beam expansion in the x-axis direction. The reflectivity characteristics and respective periods d of diffractive optics IDO, ODO, TO, together with the orientations of their respective grating vectors, provide for beam expansion in two dimensions while preserving the intended relationships among the angularly related beams of image-bearing light WI that are output from image light guide 20 as image-bearing light WO.

While image-bearing light WI input into image light guide 20 is encoded into a different set of angularly related beams by in-coupling diffractive optic IDO, the information required to reconstruct the image is preserved by accounting for the systematic effects of in-coupling diffractive optic IDO. Intermediate optic TO, located in an intermediate position between in-coupling and out-coupling diffractive optics IDO, ODO, is typically arranged so that it does not induce any significant change on the encoding of image-bearing light WG. Out-coupling diffractive optic ODO is typically arranged in a symmetric fashion with respect to in-coupling diffractive optic IDO, e.g., including diffractive features sharing the same period. Similarly, the period of intermediate optic TO also typically matches the common period of in-coupling and out-coupling diffractive optics IDO, ODO. As illustrated in FIG. 2, grating vector kl of intermediate optic TO may be oriented at forty-five degrees (45°) with respect to the other grating vectors k0, k2 (all as undirected line segments). However, in an embodiment, grating vector k1 of the intermediate optic TO is oriented at sixty degrees (60°) to grating vectors k0, k2 of in-coupling and out-coupling diffractive optics IDO, ODO in such a way that image-bearing light WG is turned one hundred and twenty degrees (120°). By orienting grating vector kl of intermediate optic TO at sixty degrees (60°) with respect to grating vectors k0, k2 of in-coupling and out-coupling diffractive optics IDO, ODO, grating vectors k0, k2 are also oriented at sixty degrees (60°) with respect to each other (again considered as undirected line segments). The three grating vectors k0, k1, k2 (as directed line segments) form an equilateral triangle, and sum to a zero-vector magnitude, which avoids asymmetric effects that could introduce unwanted aberrations including chromatic dispersion.

Image-bearing light WI that is diffracted into planar waveguide 22 is effectively encoded by in-coupling diffractive optic IDO, whether in-coupling diffractive optic IDO uses gratings, holograms, prisms, mirrors, or some other mechanism. Any reflection, refraction, and/or diffraction of light that takes place at in-coupling diffractive optic IDO must be correspondingly decoded by out-coupling diffractive optic ODO to re-form the virtual image that is presented to the viewer. Intermediate optic TO, placed at an intermediate position between in-coupling and out-coupling diffractive optics IDO, ODO, is typically designed and oriented so that it does not induce any change on the encoded light. Out-coupling diffractive optic ODO decodes image-bearing light WG into its original or desired form of angularly related beams that have been expanded to fill eyebox E.

Whether any symmetries are maintained or not among intermediate optic TO and in-coupling and out-coupling diffractive optics IDO, ODO, or whether any change to the encoding of the angularly related beams of image-bearing light WI takes place along planar waveguide 22, intermediate optic TO and in-coupling and out-coupling diffractive optics IDO, ODO are related so that image-bearing light WO that is output from planar waveguide 22 preserves or otherwise maintains the original or desired form of image-bearing light WI for producing the intended virtual image.

The letter “R” represents the orientation of the virtual image that is visible to the viewer whose eye is in eyebox E. As shown, the orientation of the letter “R” in the represented virtual image matches the orientation of the letter “R” as encoded by image-bearing light WI. A change in the rotation about the z-axis or angular orientation of incoming image-bearing light WI with respect to the x-y plane causes a corresponding symmetric change in rotation or angular orientation of outgoing light from out-coupling diffractive optic ODO. From the aspect of image orientation, intermediate optic TO simply acts as a type of optical relay, providing expansion of the angularly encoded beams of image-bearing light WG along one axis (e.g., along the y-axis) of the image. Out-coupling diffractive optic ODO further expands the angularly encoded beams of image-bearing light WG along another axis (e.g., along the x-axis) of the image while maintaining the original orientation of the virtual image encoded by image-bearing light WI. As illustrated in FIG. 2, intermediate optic TO may be a slanted or square grating arranged on the front or back (i.e., first or second) surfaces of planar waveguide 22. Alternately, intermediate optic TO may be a blazed grating.

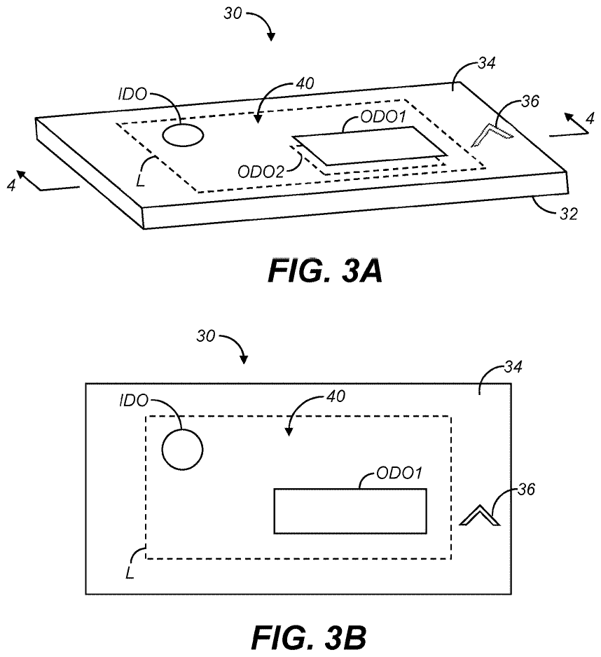

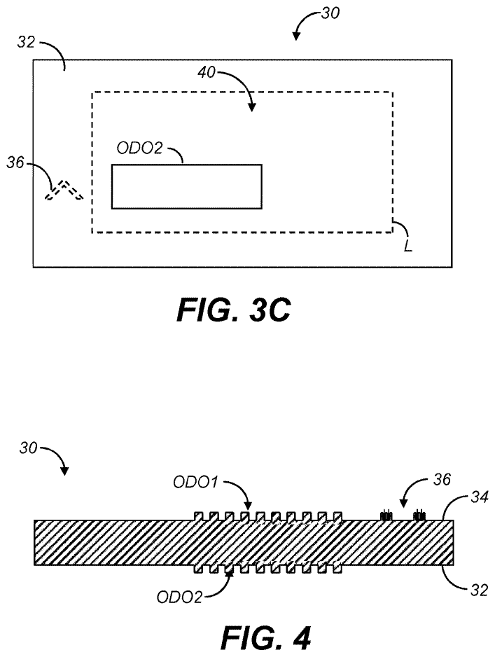

FIGS. 3A-17 show exemplary embodiments of an image light guide forming system 110, 112, 114, 116, 118 (discussed below), respective components of image light guide forming system 110, 112, 114, 116, 118, and/or one or more image light guides 40 (discussed below), formed from a substrate 30 (discussed below) by one or more forming operations of image light guide forming system 110, 112, 114, 116, 118. As will be discussed below in detail, image light guide forming system 110, 112, 114, 116, 118 is operable to form diffractive optics (e.g., out-coupling diffractive optic ODO1 and out-coupling diffractive optic ODO2) on respective surfaces of image light guide 40, e.g., on top surface 34 and bottom surface 32, respectively (discussed below).

FIG. 3A is a top perspective view of substrate 30. FIG. 3B is a top plan view of the substrate 30. FIG. 3C is a bottom plan view of substrate 30. In an exemplary embodiment, substrate 30 is operatively arranged to facilitate the creation of an image light guide 40, and comprises bottom surface 32 and top surface 34. In exemplary embodiments, substrate 30 comprises at least one of glass, silicon, polymethyl methacrylate (PMMA), fused quartz, fused silica, polyethylene terephthalate (PET), or any other optically transparent or translucent material. In an exemplary embodiment, fiducial 36 is formed on or in substrate 30 at the same time that a diffractive optic is formed on or in substrate 30, as described in greater detail below. Image light guide forming system 110, 112, 114, 116, 118 is arranged to form in-coupling diffractive optic IDO, out-coupling diffractive optic ODO1, and fiducial 36 in top surface 34. In some examples, substrate 30 is flipped over, fiducial 36 is aligned with a fiducial located on at least one component of image light guide forming system 110, 112, 114, 116, 118 (e.g., a plate, platform, surface, mold, etc.), and out-coupling diffractive optic ODO2 is formed in bottom surface 32, as will be described in greater detail below. Due to the transparency or translucency of substrate 30, fiducial 36 is also visible from bottom surface 32 (see FIG. 3C). It should be appreciated that formation of diffractive features in substrate 30, and/or singulation of the portions of the substrate 30 that comprise the diffractive features, forms image light guide 40. In an exemplary embodiment, once the desired diffractive features are formed in substrate 30, image light guide 40 is separated from substrate 30, for example along perimeter line L. In an exemplary embodiment, fiducial 36 is arranged outside of the perimeter of image light guide 40 (i.e., outside of line L). Although large fiducials are illustrated in FIGS. 3A and 3B, the fiducials may be microscopic in size and essentially invisible to the naked eye.

In an exemplary embodiment, fiducial 36 is formed in substrate 30 prior to formation of a diffractive optic on substrate 30. Fiducial 36 may be formed on or in surface 34 via laser engraving or marking, press, mold, curing, burning, scribing, ink, etc., and is thus visible on surface 34, for example, via the unaided human eye, a camera, an optical sensor, or the like.

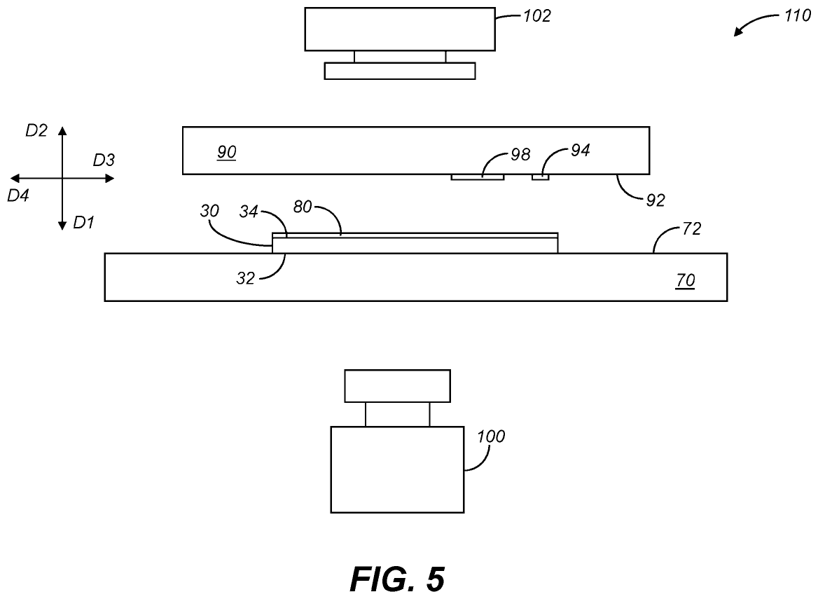

FIG. 4 is a cross-sectional view of substrate 30 taken generally along line 4-4 in FIG. 3A. In an exemplary embodiment, fiducial 36 comprises a plurality of diffractive features such that it can be more visible within the transparent substrate 30. For example, as shown, fiducial 36 is a surface relief diffraction grating including a plurality of grooves, ridges, and/or protrusions arranged along surface 34. However, fiducial 36 could alternately comprise a volume hologram, liquid crystal material, or other holographic diffraction element, or other type of optical component arranged along the substrate 30 that provides diffraction of incident light.

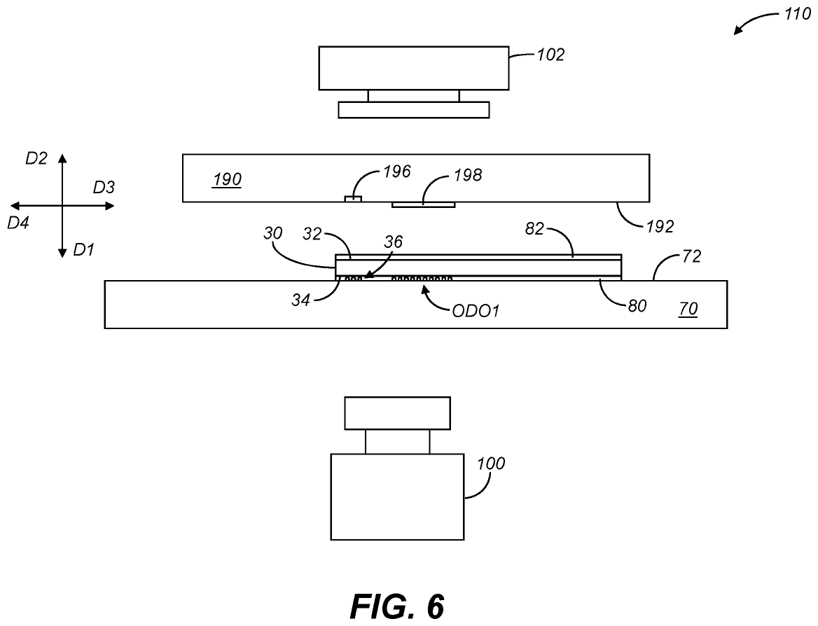

FIG. 4 shows out-coupling diffractive optics ODO1 and ODO2 and fiducial 36 comprising a positive pattern of features, in this case linear diffractive features. Such positive pattern of features is created by a mold having a negative pattern of features (see FIG. 6). In addition to its ordinary meaning to those skilled in the art, the term “positive pattern of features” is intended to describe features that protrude from an outer surface of the substrate or mold (e.g., ridges that protrude proudly from a surface). In addition to its ordinary meaning to those skilled in the art the term “negative pattern of features” is intended to describe features that are recessed into or within a component from an outer surface thereof (e.g., grooves pressed into a surface). As will be described below in detail, negative mold features, when filled with a curable material, will form positive diffractive features on a substrate as shown in FIGS. 5-6. It should be appreciated that, out-coupling diffractive optic ODO1, out-coupling diffractive optic ODO2, and/or fiducial 36 can be formed using a negative or positive plurality of mold features such that the cured features can be negative or positive diffractive features. Positive mold features, which would create negative diffractive features on a substrate, are shown in FIGS. 5-6 and 7-10.

FIGS. 5-6 show side elevational views of image light guide forming system 110. Image light guide forming system 110 generally comprises platform 70, mold or surface or plate or mold 90 (referred to herein as “mold 90”), and mold or surface or plate or mold 190 (referred to herein as “mold 190”). Molds 90 and 190 are optically flat parts operatively arranged to form diffractive optics and at least one fiducial on or in one or more substrates 30. In an exemplary embodiment, mold 90 and/or mold 190 comprise(s) a rigid plate.

In one example, platform 70 supports and secures substrate 30 during one or more molding processes. In an exemplary embodiment, platform 70 comprises one or more fiducials formed therein, for example, a fiducial formed on or in surface 72. It should be appreciated that such a fiducial may comprise mold features or diffractive features (e.g., gratings) as described above with respect to fiducial 36.

Mold 90 comprises surface 92 and one or more fiducials, for example, fiducial 94. In one example, fiducial 94 comprises a positive pattern of mold features or diffractive features (e.g., gratings) for forming fiducial 36 on substrate 30. In an exemplary embodiment, mold 90 further comprises diffractive features operatively arranged to create diffractive optics on substrate 30 (or image light guide 40). For example, as shown, mold 90 comprises diffractive features 98 arranged on, in, or along surface 92. It should be appreciated that diffractive features 98 may comprise a plurality of grooves arranged in surface 92 (a negative pattern of diffractive features) or a plurality of ridges extending from surface 92 (a positive pattern of diffractive features) operatively arranged to engage a surface of, or coating arranged on, substrate 30 and create diffractive optics therein.

During a forming process, substrate 30 is arranged on or is otherwise secured to surface 72 of platform 70. Mold 90 is arranged over substrate 30. Platform 70 and/or mold 90 is displaced in direction DI and/or direction D2, (e.g., mold 90 is displaced in direction D1 with respect to platform 70, or platform 70 is displaced in direction D2 with respect to mold 90) such that diffractive features 98, upon compression and curing of a curable material deposited on substrate 30, form diffractive optics and fiducial 36 in the curable material to form image light guide 40. The diffractive optics may include one or more in-coupling diffractive optics, one or more intermediate diffractive optics (also referred to as “turning optics”), and one or more out-coupling diffractive optics. Thus, the first molding operation forms at least one diffractive optic (e.g., IDO, TO, and/or ODO1) and at least one fiducial 36 in the curable material proximate the first surface 34 of the substrate 30.

In an exemplary embodiment, substrate 30 further comprises at least one outer layer, for example, layer 80 and layer 82. In an exemplary embodiment, layers 80 and 82 comprise an optically transparent, ultraviolet (UV) curable polymer. Prior to forming diffractive optics and the fiducial in substrate 30, one or more layers are applied thereto. For example, layer 80 may be applied to surface 34 and/or layer 82 may be applied to surface 32. Layers 80 and 82 are planar layers operatively arranged to form parallel opposing surfaces of substrate 30. Layers 80 and 82 may also act as an adhesive, allowing substrate 30 to temporarily adhere to platform 70 and/or mold 90. However, it should be appreciated that in an exemplary embodiment, platform 70 and/or mold 90 may comprise one or more vacuum channels operable to hold substrate 30 thereto via a negative pressure. In one exemplary embodiment, layers 80 and 82 generally comprise a material that optically matches, i.e., matches the index of refraction within 5% of, the material of substrate 30. In another exemplary embodiment, layers 80 and 82 generally comprise a high index material, e.g., an optically transparent material with an index of refraction greater than or equal to 1.7. In an exemplary embodiment, layers 80 and 82 comprise a material that is softer than the material of substrate 30.

In an exemplary embodiment, layer 80 is applied to surface 34 as a liquid (e.g., via a print head, spray nozzle, pipet, computer controlled metered dispenser, etc.). Substrate 30 may then be arranged on or aligned with surface 92 of mold 90 (or surface 72 of platform 70) wherein layer 80, deposited in the liquid state via a print head, spray nozzle, pipet, computer-controlled meter dispenser, etc., adheres substrate 30 to mold 90. Pressure may be applied to substrate 30 such that surface 32 and the outer surface of layer 80 (i.e., at surface 92) are parallel. In an exemplary embodiment, layer 80 is then cured, for example using UV light from UV lamp 102, transforming layer 82 into a solid. In some example embodiments, as will be described below in detail, the substrate 30 is then flipped, and the processes described above is repeated to form layer 82 on the bottom surface 32 of the substrate 30. In such exemplary embodiments, diffractive optics and the fiducial are formed in layers 80 and/or 82.

In an exemplary embodiment, surface 72 comprises a UV reflective material (e.g., nickel or silicon), either rigid or non-rigid, and surface 92 comprises a UV transmissive material such that UV light can be directed through surface 92 toward surface 72, and reflect off of surface 72, during the curing process (for example using UV lamp 102). It should be appreciated that in an exemplary embodiment, surface 92 comprises a UV reflective material (e.g., nickel or silicon), either rigid or non-rigid, and surface 72 comprises a UV transmissive material such that UV light can be directed through surface 72 toward surface 92, and reflect off of surface 92, during the curing process. In such exemplary embodiments, UV light is directed through one of surface 72 and surface 92, through substrate 30 and its respective layers 80 and/or 82, reflects off of the other of surface 72 and surface 92, and back through substrate 30 and/or its respective layers 80 and/or 82. For example, as shown in FIG. 5, UV light emitted from UV lamp 102 is directed through mold 90 and surface 92, through layer 80 and substrate 30, reflects off of 72, and back through substrate 30 and 80. This provides the UV curable layers with maximum exposure to UV light for optimal curing.

Once diffractive optics, for example out-coupling diffractive optic ODO1, and fiducial 36 are formed on a first side of substrate 30 in layer 80, substrate 30 may be flipped over such that layer 80 substantially abuts against surface 72. Fiducial 36 is aligned with fiducial 196 (shown in FIG. 6) of mold 190. In an exemplary embodiment, fiducial 36 may be aligned with fiducial 196 such that mold 190 is properly aligned with substrate 30. Mold 190 comprises surface 192 and one or more fiducials, for example, fiducial 196. In an exemplary embodiment, fiducial 196 comprises a negative or positive pattern of mold features or diffractive features (e.g., gratings) for forming a fiducial on substrate 30. In an exemplary embodiment, fiducial 196 does not form a fiducial on substrate 30. In an exemplary embodiment, mold 190 further comprises diffractive features operatively arranged to create diffractive optics on substrate 30 (or image light guide 40). For example, as shown, mold 190 comprises diffractive features 198 arranged on, in, or along surface 192. In one example, diffractive features 198 may comprise a plurality of grooves arranged in surface 192 (a negative pattern of diffractive features) or a plurality of ridges extending from surface 192 (a positive pattern of diffractive features) operatively arranged to engage a surface of, or coating or other material arranged on, substrate 30 and create diffractive optics therein (e.g., out-coupling diffractive optic ODO2 shown in FIGS. 3A-4). In an exemplary embodiment, in addition to ensuring that fiducial 36 and fiducial 196 are aligned before the second forming process shown in FIG. 6, fiducials 36 and 196 could also be aligned with an additional fiducial located on or in one or more surfaces of platform 70.

Fiducial 36 of substrate 30 is aligned with fiducial 196 of mold 190, for example using camera or sensor 100 (see FIG. 6). The alignment of fiducials 36, 196 ensures proper alignment of the diffractive features formed on or in layer 80 from the first forming process, e.g., in-coupling diffractive optic IDO and out-coupling diffractive optic ODO1, with diffractive features 198. Subsequently, diffractive optics are formed in layer 82 via mold features 198 (i.e., using the directions D1-D2 methods described above).

In an exemplary embodiment, alignment of the fiducials is detected and/or verified by vision system 100. For example, the vision system 100 may include a light source, a camera and/or optical sensors, image sensors, one or more processors, imaging software, and image processing software, or the like. Other optical alignment techniques to ensure fiducial alignment may include light emitting diode (LED) or laser light sources and one or more photodiodes. Additionally or alternatively, alignment of the fiducials is detected by the aided or unaided human eye. The alignment of fiducial 94 with fiducial 36 and fiducial 74 properly aligns mold 90, 190 with respect to substrate 30 and/or platform 70 in direction D3 and direction D4, and direction D5 and direction D6.

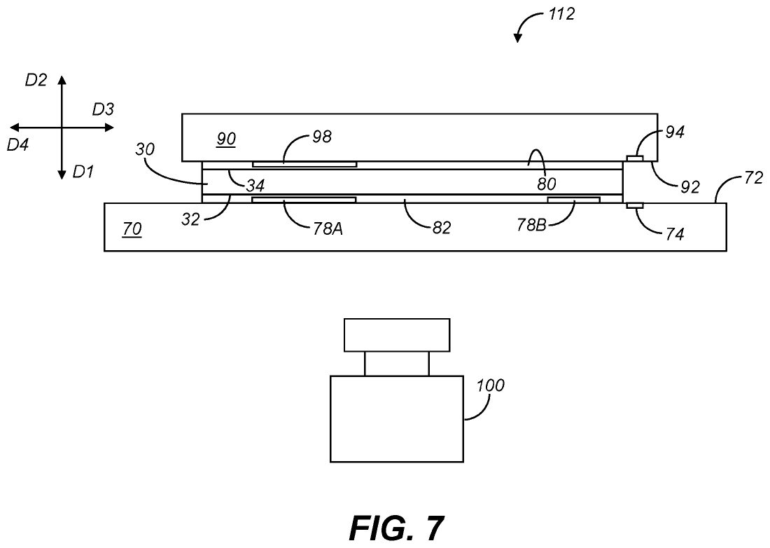

FIG. 7 is a side elevational view of image light guide forming system 112 configured to imprint diffractive features into layers 80 and 82 in a single curing process. For example, image light guide forming system 112 comprises mold 70 and mold 90. In an exemplary embodiment, image light guide forming system 112 further comprises vision system 100. Mold 70 comprises surface 72 including fiducial 74 and at least one set of diffractive features, for example, diffractive features 78A and diffractive features 78B. Mold 90 comprises surface 92 including fiducial 94 and at least one set of diffractive features, for example, diffractive features 98. As shown, substrate 30 is arranged between surface 72 and surface 92. As previously described, layers 80 and 82 can be deposited between surface 92 and surface 34 and between surface 72 and surface 32. Molds 70 and 90 are then aligned with each other and leveled, for example, by aligning fiducial 94 with fiducial 74. The alignment of fiducials 94 and 74 ensures that diffractive features 78A and 98 are properly aligned. In an exemplary embodiment, alignment of fiducials 74 and 94 is detected and/or verified by vision system 100 and/or by the aided or unaided human eye. Once proper alignment between molds 70 and 90 is achieved, molds 70 and 90 are displaced to form diffractive optics in layers 80 and 82 simultaneously (e.g., using the directions D1-D2 methods described above). Once, compressed, layers 80 and 82 can be cured, e.g., via exposure to UV light. An advantage of image light guide forming system 112 is that properly aligned diffractive optics can be formed in both sides of substrate 30 at the same time, leading to increased waveguide production speed.

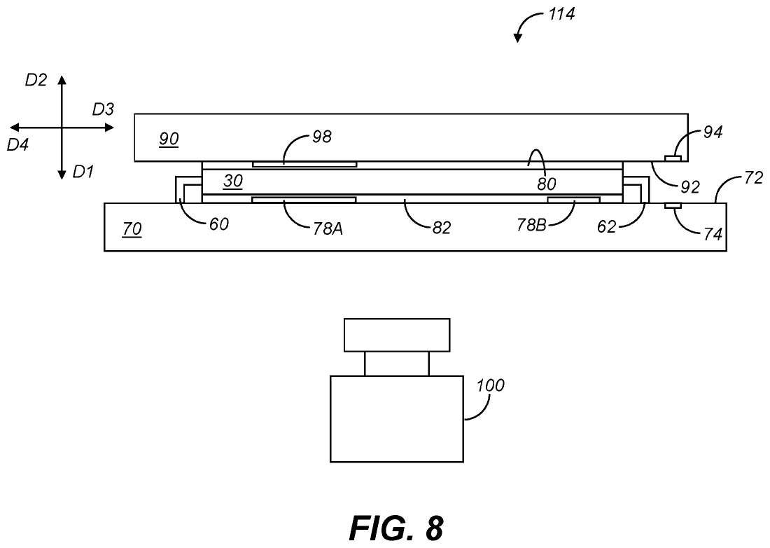

FIG. 8 is a side elevational view of image light guide forming system 114 that utilizes one or more alignment protrusions 60, 62. For example, image light guide forming system 114 comprises mold 70 and mold 90. In an exemplary embodiment, image light guide forming system 114 further comprises vision system 100. Mold 70 comprises surface 72 including fiducial 74 and at least one set of diffractive features, for example, diffractive features 78A and diffractive features 78B. Mold 90 comprises surface 92 including fiducial 94 and at least one set of diffractive features, for example, diffractive features 98. Image light guide forming system 114 further comprises at least one alignment protrusion or pin, for example alignment protrusion 60 and alignment protrusion 62. Alignment protrusions 60 and 62 act as mechanical stops to physically prevent movement or displacement of substrate 30 during the curing processes described herein as well as ensure proper alignment with the molds 70 and 90. Alignment protrusions 60 and 62 are connected to at least one of mold 70 and mold 90 and are operatively arranged to removably engage substrate 30. Specifically, alignment protrusions 60 and 62 engage a perimeter or one or more edges of substrate 30 to align substrate 30 to a mold (i.e., mold 70 or mold 90). In an exemplary embodiment, alignment protrusions 60 and 62 are raised such that they only contact the center of the sidewall or edge of substrate 30 (i.e., between layers 80 and 82). In an exemplary embodiment, alignment protrusions 60 and 62 comprise a hydrophobic coating. Alignment protrusions 60 and 62 provide a mechanical alignment means. As shown, substrate 30 is arranged on surface 72 and aligned on mold 70 using alignment protrusions 60 and 62. In an exemplary embodiment, three edges of substrate 30 are engaged with three alignment protrusions, thereby ensuring proper alignment of substrate 30 with respect to mold 70. Molds 70 and 90 are then aligned and leveled, for example, by aligning fiducial 94 with fiducial 74. The alignment of fiducials 74 and 94 ensures that diffractive features 78A and 98 are properly aligned. In an exemplary embodiment, alignment of fiducials is detected and/or verified by vision system 100. Once proper alignment between molds 70 and 90 is achieved, molds 70 and 90 are displaced to form diffractive optics in layers 80 and 82 simultaneously (e.g., using the directions D1-D2 methods described above). Once, compressed, layers 80 and 82 can be cured, e.g., via exposure to UV light. An advantage of image light guide forming system 114 is that properly aligned diffractive optics can be formed in both sides of substrate 30 at the same time, leading to increased waveguide production.

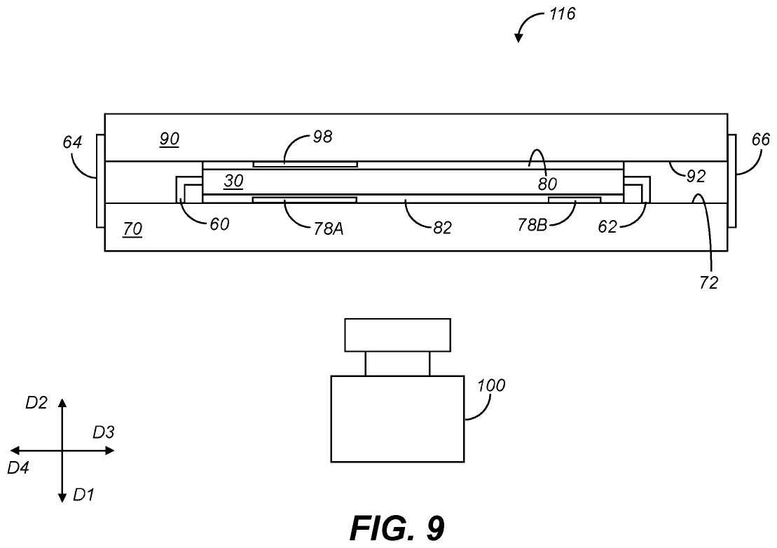

FIG. 9 is a side elevational view of image light guide forming system 116 with one or more additional alignment protrusions, for example alignment protrusions 64 and 66. Image light guide forming system 116 comprises mold 70 and mold 90. In an exemplary embodiment, image light guide forming system 116 further comprises vision system 100. Mold 70 comprises surface 72 including at least one diffractive optic marking, for example, diffractive features 78A and diffractive features 78B. Mold 90 comprises surface 92 including at least one set of diffractive features, for example, diffractive features 98. Mold 70 and mold 90 comprise at least one matching dimension for alignment purposes. For example, in the embodiment shown, at least the width of mold 70 is equal to the width of mold 90 (i.e., the width being measured along direction D3). In an exemplary embodiment, the dimensions of mold 70 is equal to the dimensions of mold 90. In an exemplary embodiment, image light guide forming system 116 further comprises at least one alignment protrusion or pin, for example alignment protrusion 60 and alignment protrusion 62. Alignment protrusions 60 and 62 act as mechanical fiducials. In the exemplary embodiment shown, alignment protrusions 60 and 62 are connected to mold 70; although it should be appreciated that in an exemplary embodiment alignment protrusions are also connected to mold 90. Alignment protrusions 60 and 62 are operatively arranged to engage substrate 30. Specifically, alignment protrusions 60 and 62 engage a perimeter or one or more edges of substrate 30 to align substrate 30 to mold 70. In an exemplary embodiment, alignment protrusions 60 and 62 are raised such that they only contact the center of the sidewall or edge of substrate 30. In an exemplary embodiment, alignment protrusions 60 and 62 comprise a hydrophobic coating. Image light guide forming system 116 further comprises at least one alignment protrusion, for example alignment protrusion 64 and alignment protrusion 66, operatively arranged to align molds 70 and 90. Alignment protrusions 60, 62, 64, and 66 provide a mechanical alignment means.

As shown, substrate 30 is arranged on surface 72 and aligned on mold 70 using alignment protrusions 60 and 62. In an exemplary embodiment, three edges of substrate 30 are engaged with three alignment protrusions, thereby ensuring proper alignment of substrate 30 with respect to mold 70. Molds 70 and 90 are then aligned and leveled, for example, using alignment protrusions 64 and 66. Alignment protrusions 64 and 66 engage the respective perimeters of mold 70 and mold 90 to ensure that molds 70 and 90, and thus diffractive features 78A and 98, are properly aligned. In an exemplary embodiment, image light guide forming system 116 comprises three perimeter alignment protrusions that engage three respective edges on each of mold 70 and mold 90, thereby ensuring proper alignment of molds 70 and 90. Once proper alignment between molds 70 and 90 is achieved, molds 70 and 90 are displaced to form diffractive optics in layers 80 and 82 simultaneously (e.g., using the directions D1-D2 methods described above). Once compressed, layers 80 and 82 can be cured, e.g., via exposure to UV light. An advantage of image light guide forming system 116 is that properly aligned diffractive optics can be formed in both sides of substrate 30 at the same time, leading to increased waveguide production.

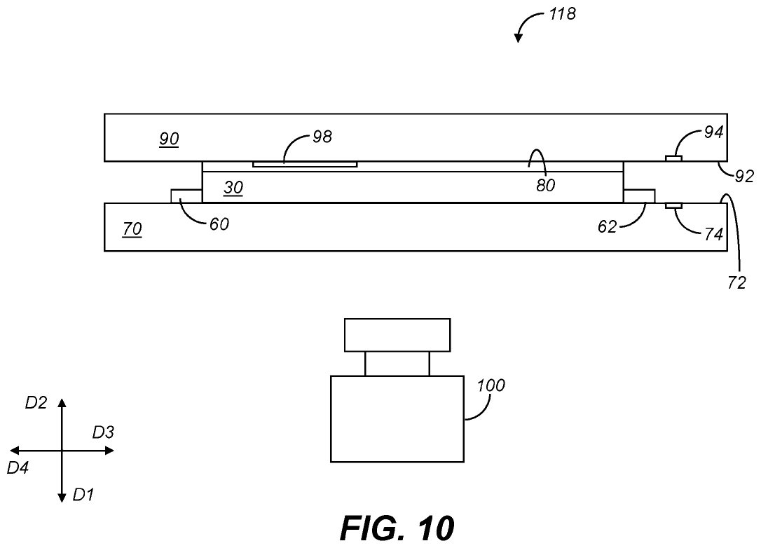

FIG. 10 is a side elevational view of image light guide forming system 118 having one exemplary arrangement of diffractive features formed thereon. Image light guide forming system 118 comprises mold 70 and mold 90. In an exemplary embodiment, image light guide forming system 118 further comprises vision system 100. Mold 70 comprises surface 72. Mold 90 comprises surface 92 including at least one set of diffractive features, for example, diffractive features 98. In an exemplary embodiment, mold 90 may comprise fiducial 94 operatively arranged to align mold 90 with mold 70, for example via vision system 100. Image light guide forming system 118 further comprises at least one alignment protrusion or pin, for example alignment protrusion 60 and alignment protrusion 62. Alignment protrusions 60 and 62 act as mechanical fiducials. In the embodiment shown, alignment protrusions 60 and 62 are connected to mold 70; although it should be appreciated that in an exemplary embodiment alignment protrusions 60 and 62 are connected to mold 90. Alignment protrusions 60 and 62 are operatively arranged to engage substrate 30. Specifically, alignment protrusions 60 and 62 engage a perimeter or one or more edges of substrate 30 to align substrate 30 to mold 70. Alignment protrusions 60 and 62 provide a mechanical alignment means.

As shown, substrate 30 is arranged on surface 72 and aligned using alignment protrusions 60 and 62. In an exemplary embodiment, three edges of substrate 30 are engaged with three alignment protrusions, thereby ensuring proper alignment of substrate 30 with respect to mold 70. Molds 70 and 90 are then aligned and leveled, for example, using fiducial 94 and vision system 100. In an exemplary embodiment, vision system 100 may detect a spatial location of fiducial 94 (i.e., where fiducial 94 is located in space) to verify proper alignment of mold 90. Once proper alignment between molds 70 and 90 is achieved, molds 70 and 90 are displaced to form diffractive optics in layer 80 (e.g., using the directions D1-D2 methods described above). Once compressed, layer 80 can be cured, e.g., via exposure to UV light. If desired, substrate 30 can then be flipped over and diffractive optics can be applied to the opposite side in the same or a similar fashion to form diffractive optics in layer 82. An advantage of image light guide forming system 118 is that accurately aligned diffractive optics can be formed in substrate 30, leading to increased waveguide production yield.

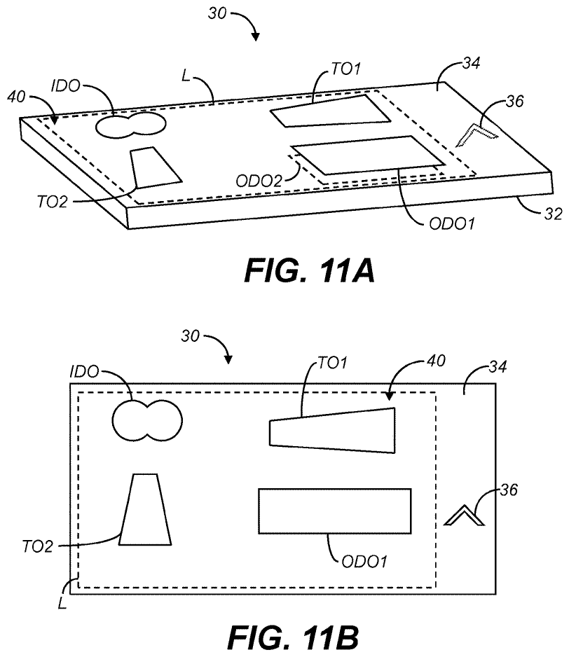

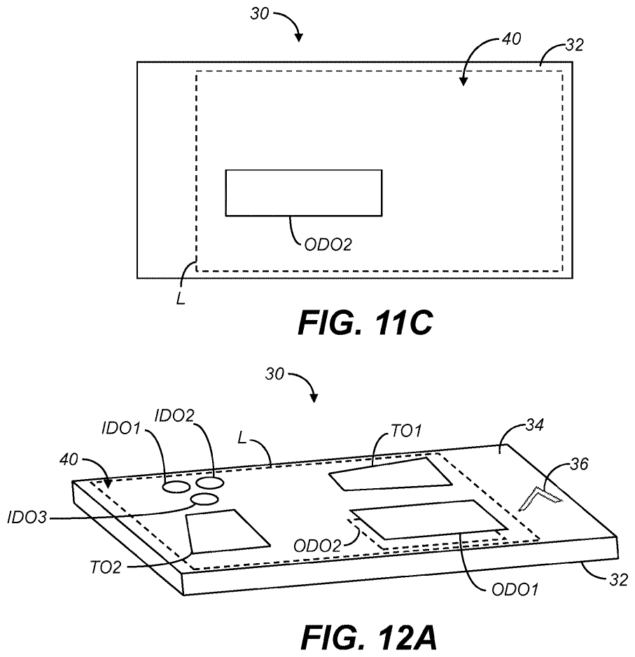

FIG. 11A is a top perspective view of an exemplary embodiment image light guide 40 formed by image light guide forming systems 110, 112, 114, 116, 118. FIG. 11B is a top plan view of image light guide 40. FIG. 11C is a bottom plan view of image light guide 40. FIGS. 11A-11C show one example implementation of the methods disclosed herein. Image light guide 40 comprises surface 32 and surface 34. Surface 34 comprises in-coupling diffractive optic IDO, turning optics TO1 and TO2, and out-coupling diffractive optic ODO1. Surface 32 comprises out-coupling diffractive optic ODO2. Out-coupling diffractive optic ODO2 is aligned with out-coupling diffractive optic ODO1 using at least one of the exemplary embodiment methods disclosed herein. By having only a single out-coupling diffractive optic on surface 32, tolerance constraints can be minimized during the alignment process. For example, only out-coupling diffractive optic ODO1 and out-coupling diffractive optic ODO2 must be aligned.

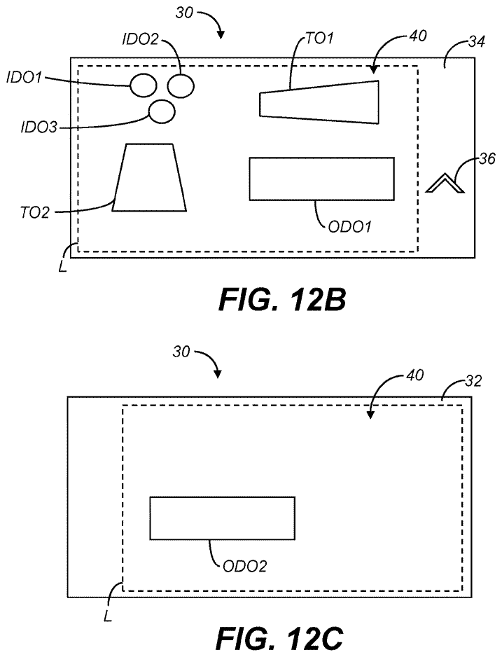

FIG. 12A is a top perspective view of an exemplary embodiment image light guide 40 formed by image light guide forming systems 110, 112, 114, 116, 118. FIG. 12B is a top plan view of image light guide 40. FIG. 12C is a bottom plan view of image light guide 40. FIGS. 12A-12C show one example implementation of the methods disclosed herein. Image light guide 40 comprises surface 32 and surface 34. Surface 34 comprises in-coupling diffractive optics IDO1, IDO2, and IDO3, turning optics TO1 and TO2, and out-coupling diffractive optic ODO1. Surface 32 comprises out-coupling diffractive optic ODO2. Out-coupling diffractive optic ODO2 is aligned with out-coupling diffractive optic ODO1 using at least one of the exemplary embodiment methods disclosed herein. In this example, the respective in-coupling diffractive optics IDO1, IDO2, and IDO3 can be optimized, using methods known to those in the art, for respective color channels. For example, in-coupling diffractive optic IDO1 can be optimized to in-couple a first wavelength range of light into image light guide 40, e.g., light with a wavelength between 520-560 nm (i.e., green light). Similarly, in-coupling diffractive optic IDO2 can be optimized to in-couple a second wavelength range of light into image light guide 40, e.g., light with a wavelength range between 440-470 nm (i.e., blue light), and in-coupling diffractive optic IDO3 can be optimized to in-couple a second wavelength range of light into image light guide 40, e.g., light with a wavelength range between 630-660 nm (i.e., red light).

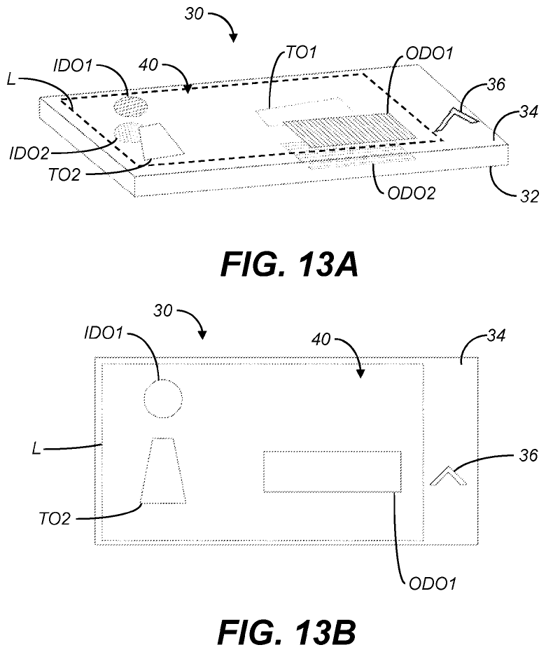

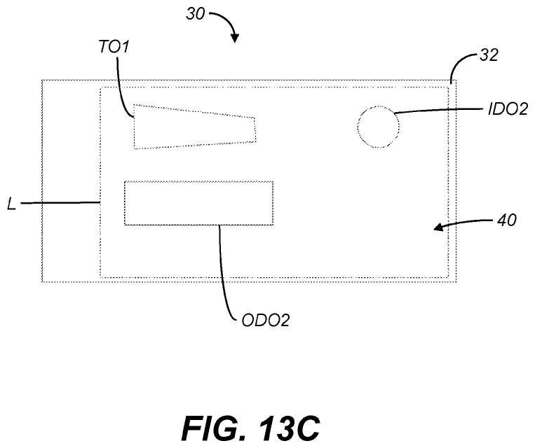

FIG. 13A is a top perspective view of an exemplary embodiment image light guide 40 formed by image light guide forming systems 110, 112, 114, 116, 118. FIG. 13B is a top plan view of image light guide 40. FIG. 13C is a bottom plan view of image light guide 40. FIGS. 13A-13C show one example implementation of the methods disclosed herein. Image light guide 40 comprises surface 32 and surface 34. Surface 34 comprises in-coupling diffractive optic IDO1, turning optic TO2, and out-coupling diffractive optic ODO1. Surface 32 comprises in-coupling diffractive optic IDO2, turning optic TOI, and out-coupling diffractive optic ODO2. Fiducial 36 is shown arranged on surface 34; however, in an exemplary embodiment, fiducial 36 may be arranged on surface 32. Out-coupling diffractive optic ODO2 may be aligned with out-coupling diffractive optic ODO1, and in-coupling diffractive optic IDO2 may be aligned with in-coupling diffractive optic IDO1, using at least one of the exemplary embodiment methods disclosed herein. It should be appreciated that, in an exemplary embodiment, the diffractive features of in-coupling diffractive optic IDO2 are arranged at an angle or turned with respect to the diffractive features of in-coupling diffractive optic IDO1 to reduce crosstalk. For example, the diffractive features of in-coupling diffractive optic IDO1 may be arranged perpendicular to the diffractive features of in-coupling diffractive optic IDO2. Similarly, in an exemplary embodiment, the diffractive features of out-coupling diffractive optic ODO2 may be arranged at an angle (e.g., 90 degrees) or turned with respect to the out-coupling the out-coupling diffractive optic ODO1.

In this example, the respective in-coupling diffractive optics IDO1 and IDO2 can be optimized, using methods known to those in the art, for different channels of the same color. For example, in-coupling diffractive optic IDOI can be optimized to in-couple red light into image light guide 40 and in-coupling diffractive optic IDO2 can also be optimized to in-couple red light into image light guide 40, creating two different light paths of red light within image light guide 40 and thus in-coupling a greater amount of red light into image light guide 40. In the embodiment shown in FIGS. 13A-13C, turning optics TO1 and TO2 are arranged on opposite surfaces, namely, surface 32 and surface 34, respectively. It should be appreciated that in an exemplary embodiment, turning optics TO1 and TO2 may be arranged on the same surface to achieve the desired dual channel result, for example, on surface 34.

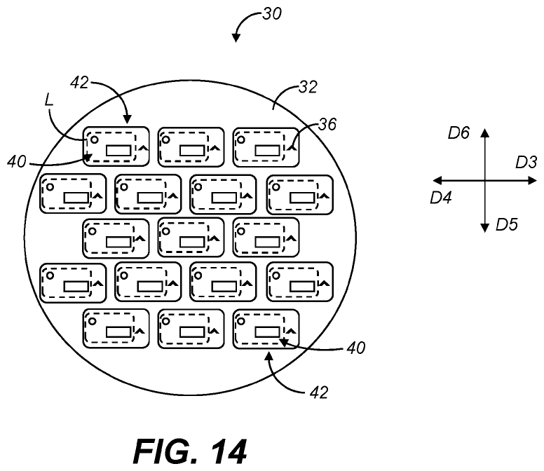

FIG. 14 is a plan view of substrate 30. In the exemplary embodiments shown, substrate 30 is a multi-pattern arrangement, where each substantially rectangular section 42 represents an individual mold pattern, where each mold pattern will encompass a completed image light guide 40. Fiducial 36 is arranged on surface 32, inside of the patterns for each of image light guides 40 but outside of the confines of line L). In the exemplary embodiment shown in FIG. 14, substrate 30 allows multiple image light guides 40 to be formed at the same time, thus increasing production speed. The large substrate with multiple image light guides 40 may be round, square or rectangular. In an exemplary embodiment, the rotational alignment tolerance between diffractive features on surface 32 and surface 34 is less than one pixel. For example, if the diffractive features described herein are generated by an image source having 1,000 horizontal pixels over a 20 degree horizontal field of view, each pixel is approximately 0.02 degrees. Thus, in some examples, the relative rotational tolerance between the diffractive features on surface 32 and surface 34 is less than +/−0.02 degrees. In other exemplary embodiments, the rotational tolerance is +/−0.01, +/−0.05, +/−0.10, or +/−0.15 degrees.

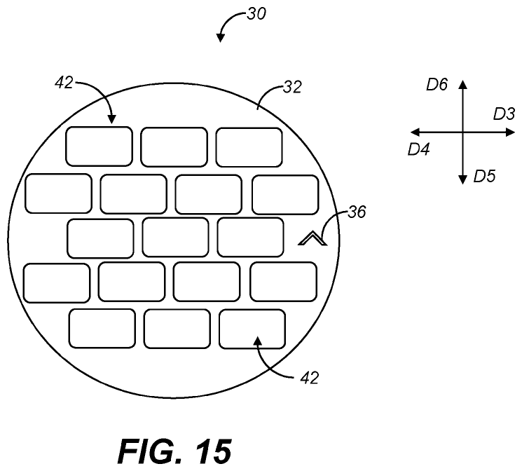

FIG. 15 is a plan view of substrate 30. In the exemplary embodiments shown, substrate 30 is operatively arranged to engage with a mold having a plurality of pre-singulated mold patterns. For example, FIG. 15 shows a multi-pattern arrangement, where each substantially rectangular section 42 represents an individual mold pattern, where each mold pattern will encompass a completed image light guide 40. As discussed above, and in one example embodiment, fiducial 36 is arranged on surface 32, outside of the patterns for each image light guide 40. In the exemplary embodiment shown in FIG. 15, substrate 30 allows multiple image light guides 40 to be formed at the same time, thus increasing production speed. In an exemplary embodiment, the rotational alignment tolerance between diffractive features on surface 32 and surface 34 is less than one pixel. In other exemplary embodiments, the rotational tolerance is +/−0.01, +/−0.05, +/−0.10, or +/−0.15 degrees.

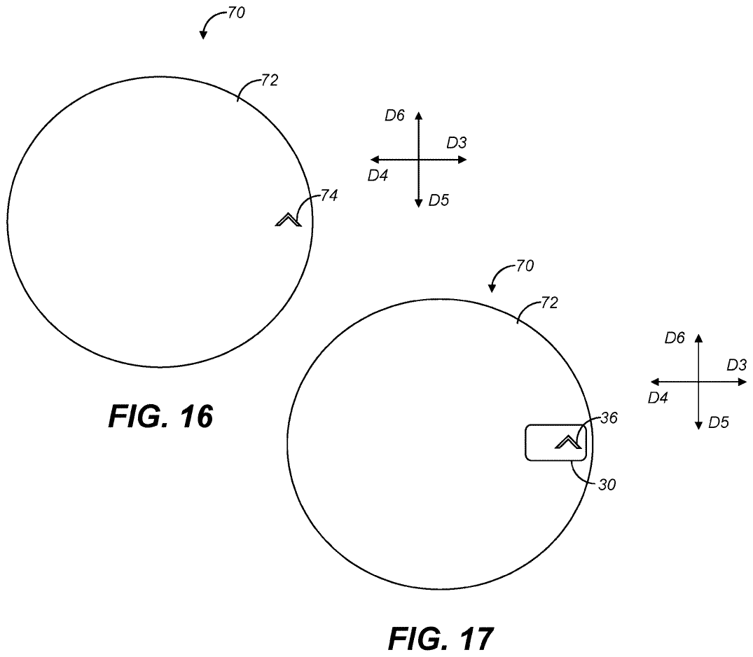

FIG. 16 is a top plan view of mold or platform 70. Mold 70 is an optically flat part operatively arranged to form diffractive features in one or more substrates 30. In an exemplary embodiment, mold 70 is a rigid plate. Mold 70 comprises surface 72 and fiducial 74 formed therein. Substrate 30 may be arranged relative to surface 72 of mold 70 such that fiducial 36 of substrate 30 is aligned with fiducial 74 of mold 70. Once proper alignment is achieved, various diffractive features can be formed in substrate 30 to form image light guides 40. It should be appreciated that fiducial 74 may comprise mold features or diffractive features (e.g., gratings) as described above with respect to fiducial 36. The alignment of fiducial 36 with fiducial 74 properly aligns substrate 30 on mold 70 in direction D3 and direction D4, and direction D5 and direction D6.

FIG. 17 is a plan view of mold 70, with substrate 30 arranged thereon. As shown, substrate 30 is arranged on surface 72 such that fiducial 36 of substrate 30 is aligned with fiducial 74 of mold 70. Once proper alignment is achieved, various diffractive features can be formed in substrate 30 to form image light guide 40. By proper alignment, it is meant that fiducial 36 is fully aligned with fiducial 74 in axial directions as well as rotational directions (i.e., angular alignment). The alignment of fiducial 36 with fiducial 74 properly aligns substrate 30 on mold 70 in direction D3 and direction D4, and direction D5 and direction D6. In an exemplary embodiment, the rotational alignment tolerance between diffractive features on surface 32 and surface 34 is less than one pixel. In other exemplary embodiments, the rotational tolerance is +/−0.01, +/−0.05, +/−0.10, or +/−0.15 degrees.

It should be appreciated that fiducial 36, 74, 94, 96 allows for lateral and rotational alignment between various elements of image light guide forming system. In an exemplary embodiment, the geometric shape of fiducial 36, 74, 94, 96 comprises symmetry. In an exemplary embodiment, the geometric shape of fiducial 36, 74, 94, 96 does not comprise symmetry. Such non-symmetric fiducial geometries may be useful for later identifying a specific side of the substrate, for example, if they are large enough to be visible by eye. In an exemplary embodiment, the geometric shape of fiducial 36, 74, 94, 96 comprises a non-rotationally symmetric fiducial to ensure proper rotational alignment and axial alignment (in directions D3, D4, D5, and D6) between fiducials during the alignment process. In an exemplary embodiment, fiducial 36, 74, 94, 96 may be formed in an edge of the substrate. In an exemplary embodiment, image light guide forming system 110, 112, 114, 116, 118 comprises a light source operatively arranged to direct light toward fiducial 36, 74, 94, 96 at an angle. Such light source illuminates fiducial 36, 74, 94, 96 for the purposes of vision system 100 or a user's eye(s).

It should be appreciated that alignment of substrate 30 may be performed manually, for example by a user, or automatically, for example by a robot arm. For manual alignment, the user may receive feedback from one or more optical sensors or vision system 100 indicating a position of substrate 30 on plate 70, 90 (e.g., that substrate 30 is aligned or not aligned). For automatic alignment, the robot arm may receive one or more signals from vision system 100 indicating a position of substrate 30, and based on the one or more signals, displace substrate 30 on plate 70, 90 until proper alignment is achieved.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

1. A method of forming an image light guide, comprising:
forming a first diffractive optic and a first fiducial on a first surface of a substrate using a first mold;
aligning the substrate with a second mold; and
forming a second diffractive optic in a second surface of the substrate, opposite the first surface.

2. The method as recited in claim 1, wherein the first diffractive optic is formed by first diffractive features arranged on the first mold and the first fiducial is formed by second diffractive features arranged on the first mold.

3. The method as recited in claim 2, wherein the first diffractive features and the second diffractive features comprise a negative pattern of diffractive features and the first diffractive optic and the first fiducial comprises a positive pattern of diffractive features.

4. The method as recited in claim 1, wherein the first diffractive optic and the first fiducial are formed in the first surface simultaneously.

5. The method as recited in claim 1, wherein the first fiducial is arranged outside of a perimeter of the image light guide.

6. The method as recited in claim 5, further comprising:
removing a portion of the substrate, the portion comprising the first fiducial.

7. The method as recited in claim 1, wherein the step of aligning the substrate with the second mold comprises:
aligning the first fiducial with a second fiducial arranged on the second mold.

8. The method as recited in claim 1, wherein at least one of the first diffractive optic portion and the first fiducial portion comprises diffractive features.

9. (canceled)

10. The method as recited in claim 1, wherein the step of aligning the substrate with a second mold comprises:
engaging the substrate with at least one alignment protrusion.

11. A method of aligning diffractive features on a substrate, the method comprising:
providing an image light guide forming system, the system including a first mold and a second mold, the first mold having first diffractive features and second diffractive features and the second mold having third diffractive features;
depositing a first material on a first surface of a substrate;
forming a first diffractive optic and a first fiducial within the first material by compressing the first mold and the first surface of the substrate; and
aligning the first fiducial of the substrate with the second fiducial of the second mold.

12. The method as recited in claim 11, further comprising:
depositing a second material on a second surface of the substrate, opposite the first surface of the substrate; and
forming a second diffractive optic within the second material by compressing the second mold and the second surface of the substrate.

13. The method as recited in claim 12, wherein the second diffractive optic is formed by the third diffractive features.

14. The method as recited in claim 11, wherein the first diffractive optic is formed by the first diffractive features and the first fiducial is formed by the second diffractive features.

15. (canceled)

16. The method as recited in claim 11, further comprising:
forming a third fiducial in the second material.

17. The method as recited in claim 11, wherein the first fiducial is arranged outside of a perimeter of the image light guide.

18. The method as recited in claim 17, further comprising:
removing a portion of the substrate along the perimeter to remove the first fiducial and form the image light guide.

19. The method as recited in claim 11, wherein the first diffractive optic and the first fiducial comprise diffractive features.

20. The method as recited in claim 11, further comprising:
curing the first material using ultraviolet light.

21. The method as recited in claim 20, wherein the step of curing the first material using ultraviolet light comprises:
arranging the substrate on a surface;
directing the ultraviolet light through one of the first mold and the surface, and then through the substrate; and
reflecting the ultraviolet light off of the other of the first mold and the surface.

22. A method of forming an image light guide, comprising:
aligning a substrate with one of a first mold and a second mold, the substrate including a first surface and a second surface, and at least the first mold comprises first negative diffractive optic features and first negative fiducial features; and
forming a first positive diffractive optic and a first positive fiducial in at least one of the first surface and the second surface;
wherein:
the first positive fiducial is arranged outside of a perimeter of the image light guide; and
the first positive diffractive optic and the first positive fiducial comprise diffractive features.
